(19) United States
(12) Patent Application Publication
(10) Pub. No.: US 2026/0121363 A1
(43) Pub. Date: Apr. 30, 2026

(54) POWER CONNECTOR WITH IMPROVED POWER TERMINALS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: YUNG-CHIH HUNG, New Taipei (TW)

(21) Appl. No.: 19/369,668

(22) Filed: Oct. 27, 2025

(30) Foreign Application Priority Data
Oct. 28, 2024 (CN) 202411514453.6

(51) Int. Cl. H01R 25/14

(52) U.S. Cl. CPC H01R 25/142

(57) ABSTRACT

A power connector includes: an insulative housing having a mating slot penetrating forward in a front-rear direction and extending in a first direction perpendicular to the front-rear direction; and two power terminals located at opposite sides of the mating slot in a second direction perpendicular to the first direction, each of the power terminals including a first piece and a second piece stacked at an outer side of the first piece in the second direction; the first piece including a first base portion, plural first elastic arms extending forward, and plural first contact portions bending from the first elastic arms, the second piece including a second base portion, plural second elastic arms extending forward, and plural second contact portions bending from the second elastic arms, wherein the second contact portions each has an opening, and the first contact portion partially extends in corresponding opening of the second contact portion.

### BACKGROUND OF THE INVENTION

### Field of the Invention

The present invention relates to a power connector capable of transmitting high current.

### Description of Related Arts

U.S. Patent Application Publication No. 2023/0155333 discloses a power connector for contacting elongated DC distribution bus bars and a method for monitoring such connections. The power connector includes first and second spring contact elements to transmit power currents. Due to the transmission of high current, temperature rise is inevitable. To detect temperature increases at a very early stage of electrical contact deterioration, a temperature sensor is added.

### SUMMARY OF THE INVENTION

An object of the present invention is to provide a power connector with improved power terminals.

In order to achieve above-mentioned object, a power connector comprises: an insulative housing having a mating slot penetrating forward in a front-rear direction and extending in a first direction perpendicular to the front-rear direction; and two power terminals located at opposite sides of the mating slot in a second direction perpendicular to the first direction, each of the power terminals comprising a first piece and a second piece stacked at an outer side of the first piece in the second direction, the first piece comprising a first base portion, plural first elastic arms extending forward from the first base portion, and plural first contact portions bending from the first elastic arms respectively, the second piece comprising a second base portion, plural second elastic arms extending forward from the second base portion, and plural second contact portions bending from the second elastic arms respectively, wherein each of the second contact portions has an opening, and the first contact portion partially extends in corresponding opening of the second contact portion.

Other objects, advantages and novel features of the present invention will become more apparent from the following detailed description of the present embodiment when taken in conjunction with the accompanying drawings.

### BRIEF DESCRIPTION OF DRAWINGS

FIG. 1 is a perspective view of the power connector and the distribution bus bar in a first embodiment of the present invention;

FIG. 2 is another perspective view of the power connector in FIG. 1;

FIG. 3 is an exploded perspective view of the power connector in FIG. 2;

FIG. 4 is a perspective view of an upper-row power terminal in FIG. 3;

FIG. 5 is a bottom view of the upper-row power terminal in FIG. 4;

FIG. 6 is a perspective view of a lower-row power terminal in FIG. 3;

FIG. 7 is a perspective view of a power connector in a second embodiment of the present invention;

FIG. 8 is another perspective view of an insulative housing in FIG. 7;

FIG. 9 is an exploded perspective view of two power assemblies in FIG. 7;

FIG. 10 is a perspective view of one power terminal in FIG. 9;

FIG. 11 is a top view of the power terminal in FIG. 10;

FIG. 12 is a front view of the power terminal in FIG. 10;

FIG. 13 is an exploded perspective view of the power terminal in FIG. 10;

FIG. 14 is a perspective view of a modified power terminal;

FIG. 15 is a front view of the power terminal in FIG. 14;

FIG. 16 is a perspective view of a power connector in a third embodiment of the present invention;

FIG. 17 is a perspective view of the power connector in the fourth embodiment of the present invention;

FIG. 18 is a perspective view of a power terminal in a fifth embodiment of the present invention;

FIG. 19 is a top view of the power terminal in FIG. 18; and

FIG. 20 is an exploded perspective view of the power terminal in FIG. 18.

### DETAILED DESCRIPTION OF THE DRAWINGS

Reference will now be made in detail to the preferred embodiments of the present invention.

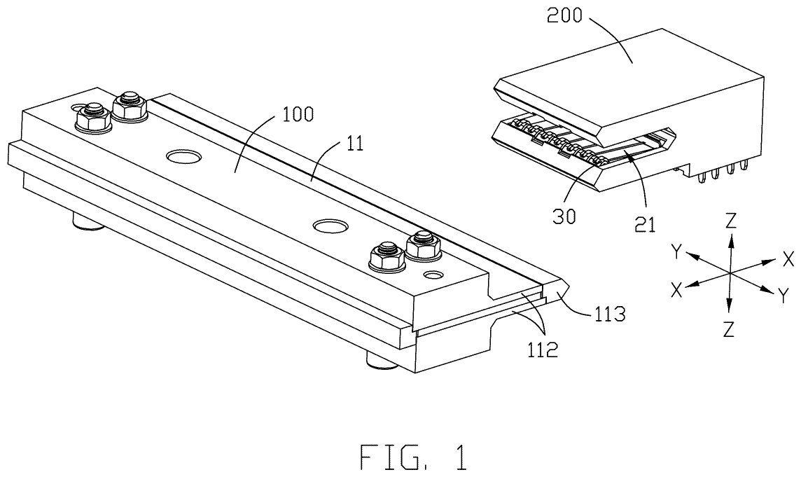

A power connector of this invention is capable of transmitting high current. In a specific embodiment, the power connector 200 is adapted for mating with a DC distribution bus bar. As shown in FIG. 1, the power connector 200 is designed to mate with bus bar 100 to transmit high current. The bus bar 100 includes a plug portion 11 including a positive conductor and a negative conductor 111, and an insulative spine 112 supporting the positive conductor and the negative conductor. The positive conductor and the negative conductor are respectively embedded on two opposite sides of the insulative spine 112. The power connector 200 can be mounted on a circuit board. When the plug portion 11 is inserted into a mating slot 21 of the power connector 200, the power terminals 30 located on both sides of the mating slot 21 respectively contact the positive and negative conductors, thereby achieving the high current transmission. The mating slot 21 penetrates forward in a front-rear direction X-X and penetrates in a first/lateral direction Y-Y, allowing the elongated plug portion 11 to pass through the mating slot in the first direction. The front-rear direction and the first direction are perpendicular to each other.

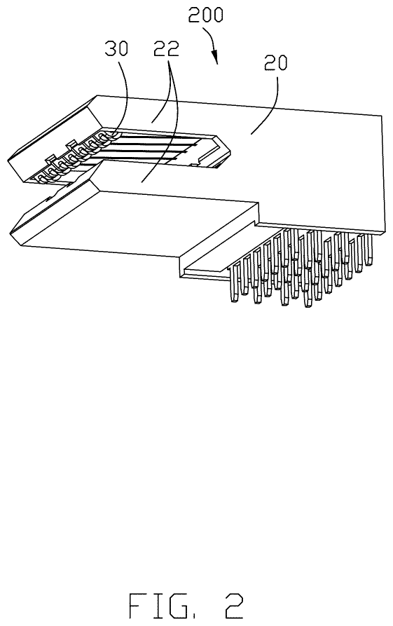

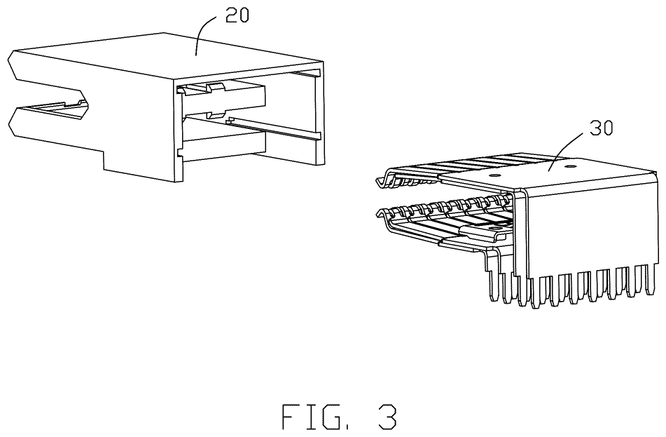

As shown in FIGS. 2-7, the power connector 200 includes an insulative housing 20 and two power terminals 30. The insulative housing 20 comprises two sidewalls 22, the mating slot 21 locates between the side walls and extends forward. In this embodiment, the front-rear direction is defined by an insertion of the plug portion with the mating slot, a front side of the mating slot is configured with the plug portion. The two power terminals 30 are located at two sides of the mating slot 21 in a second/transverse direction Z-Z, the second direction is perpendicular to the side walls 22. The first direction, the second direction and the front-rear direction are perpendicular to each other. The two power terminals 30 are located at opposite sides of the mating slot 21 in the second direction. The front parts of the two power terminals share a similar construction, the rear parts differ due to different mounting methods. One power terminal is selected for specific description thereinafter.

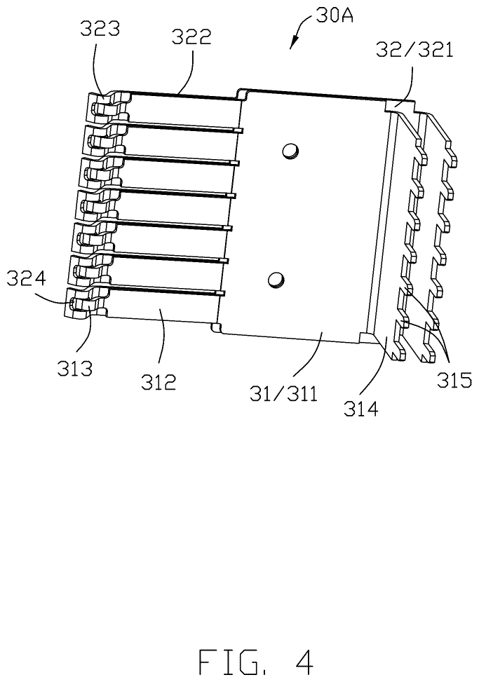

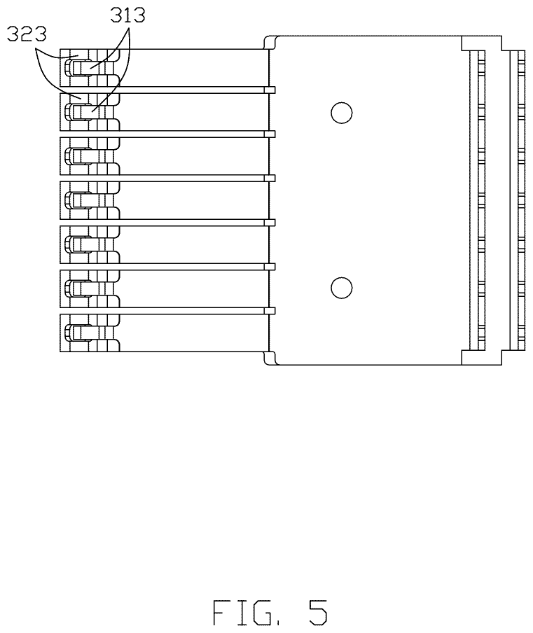

As shown in FIGS. 4-5 illustrating an upper power terminal 30A, each of the power terminal 30 includes a first piece 31 and a second piece 32, the second piece is attached to an outer side of the first piece in the second direction. an inner side is located closer to the mating slot 21, the outer side is located farther from the mating slot than the inner side. The first piece is an inner piece, and the second piece is an outer piece.

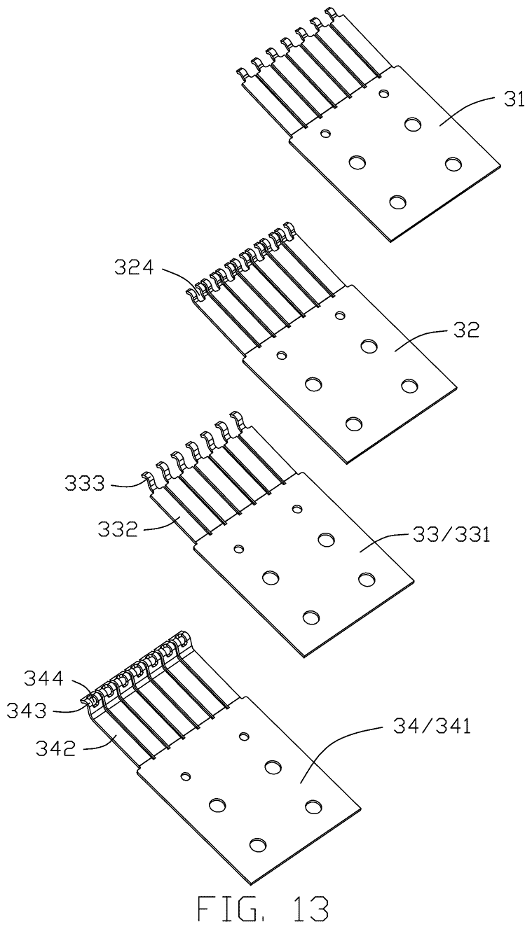

The first piece 31 includes a first base portion 311, multiple first elastic arms 312 extending forward from the first base portion 311, and first contact portions 313 bent from the front ends of the first elastic arms 312. The second piece 32 includes a second base portion 321, multiple second elastic arms 322 extending forward from the second base portion 321, and second contact portions 323 bent from the front ends of the second elastic arms 322. The second contact portions 323 have openings 324, and the first contact portions 313 partially extend into the openings 324. In this embodiment, the opening 324 penetrate an inner surface and an outer surface of the second contact portion 323 in the second direction. The opening 324 forms a closed hole. In other embodiments, the opening may be an opening hole, for example, the opening 324 opens forward as shown in FIG. 13. That means, the openings 324 of the second contact portions offer spaces for the first contact portions.

In a convention that the first contacting portions offer openings for accommodating the protrusions from the second contacting, the second contact portions or/and the second elastic arms have to abut against the first contact portion or/and the first elastic arms respectively, to keep the protrusions contacting with the bus bar. As a result, the first and the second contact portions and the first and second elastic arm have a risk to interfere with each other. In this embodiment, the interfering risk of the first and second contact portions and the first and the second elastic arms for the first contact portions, is decreased. Moreover, the first and the second elastic arms are more flexible to design, for example, the first and the second elastic arms can be designed to be sufficiently wide in the second/lateral direction, thereby offering as larger conductive surfaces as possibly to allow high current to pass through.

The first contact portions 313 of the first piece 31 are arranged in a single row along the lateral direction Y-Y, and the second contact portions 323 of the second piece 32 are also arranged in a single row along the lateral direction. The first contact portions 313 are positioned behind the second contact portions 323, i.e., deeper within the mating slot 21. Alternatively, the first contact portions can be staggered in the front-rear direction and the second contact portions can be staggered in the front-rear direction to form more rows. The second elastic arms 322 are located at the outer side of the first elastic arms 312 and aligned one by one with the first elastic arms 312 with the same width. The width of the second contact portions 323 is equal to the width of the second elastic arms 322 in the first direction, while the width of the first contact portions 313 is smaller than the width of the first elastic arms 312.

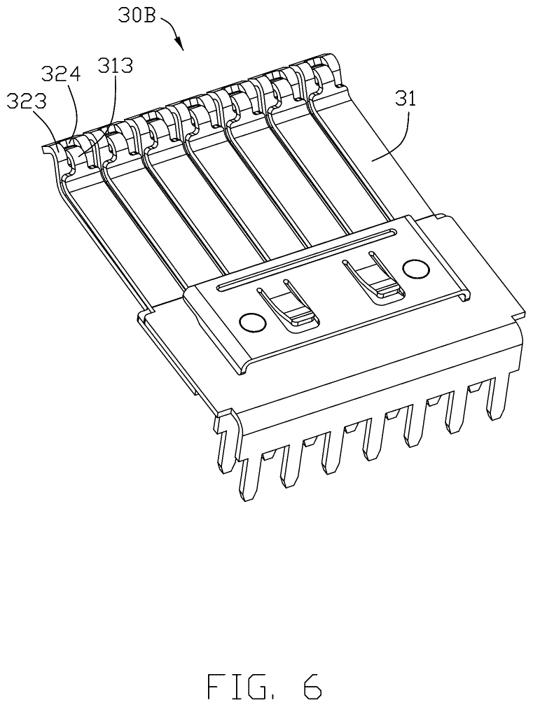

Referring to FIG. 6, the lower power terminal 30B is similar to the upper power terminal 30A, the lower power terminal 30B also includes a first piece 31 and a second piece 32. The second contact portion 323 of the second piece 32 is located at the outer side of the first contact portion and has an opening 324. The first contact portion 313 has a smaller width and is partially accommodated within the opening 324.

In this embodiment, the power connector 200 is vertically mounted on a board. A rear plate portion 314 extends from corresponding base portion, and plural soldering portions 315 extend from corresponding rear plate portion 314. The upper power terminal is larger than the lower power terminal in the front-rear direction.

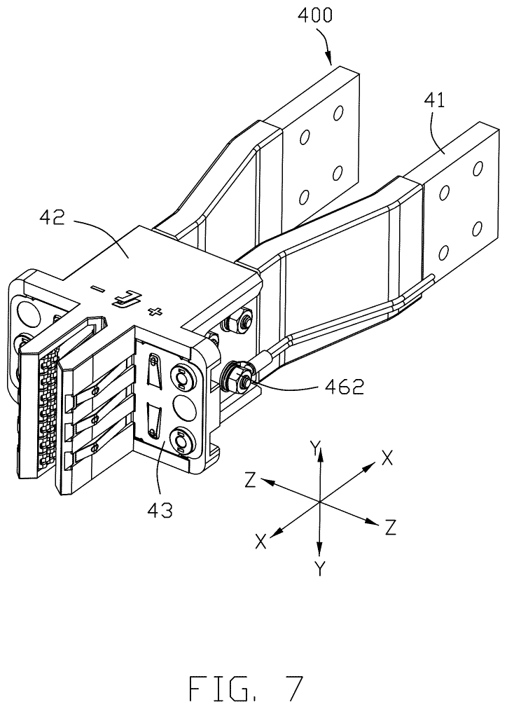

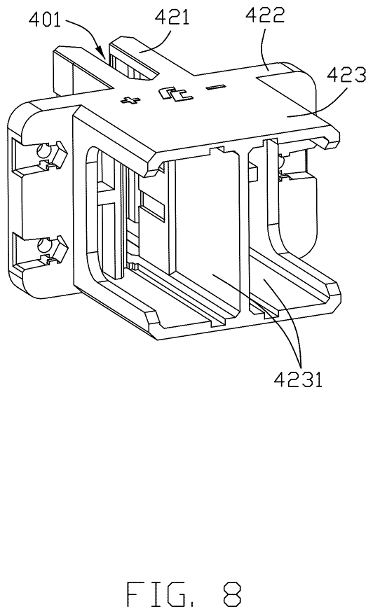

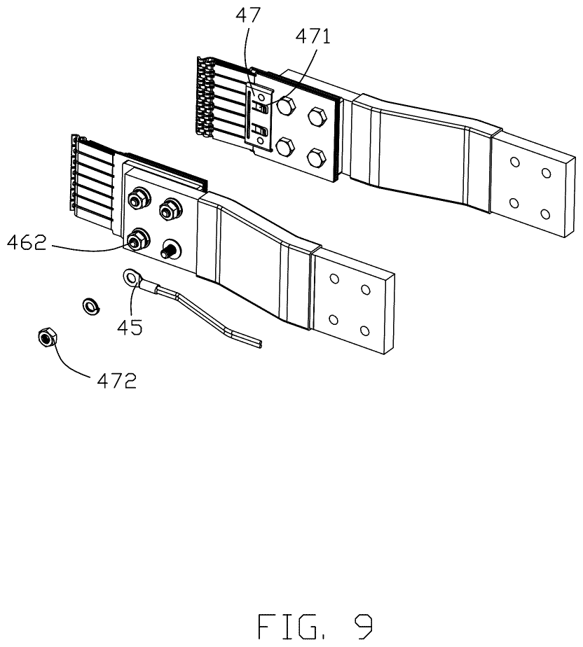

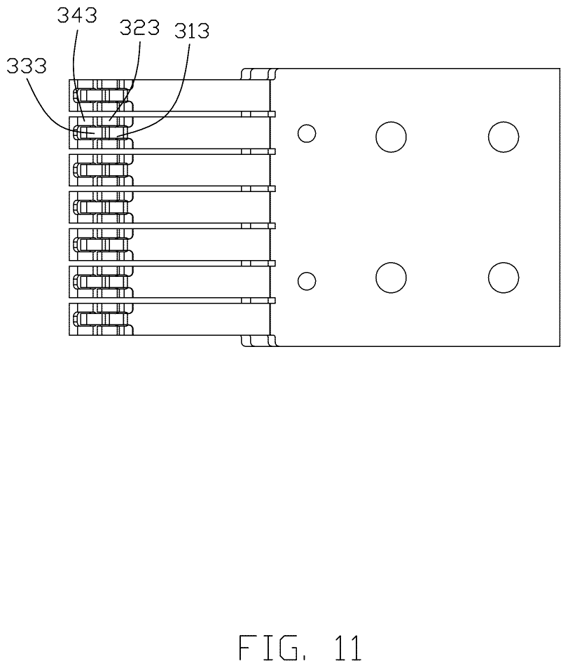

FIGS. 7-15 illustrate a power connector of a second embodiment illustrated, each of the power terminals are composed of plural terminal/metal pieces. In the second embodiment, each of the power terminals further includes a third piece 33 and a fourth piece 34. The structures of the first and the second pieces are generally the same as those in the first embodiment. The differences are primarily described hereinafter.

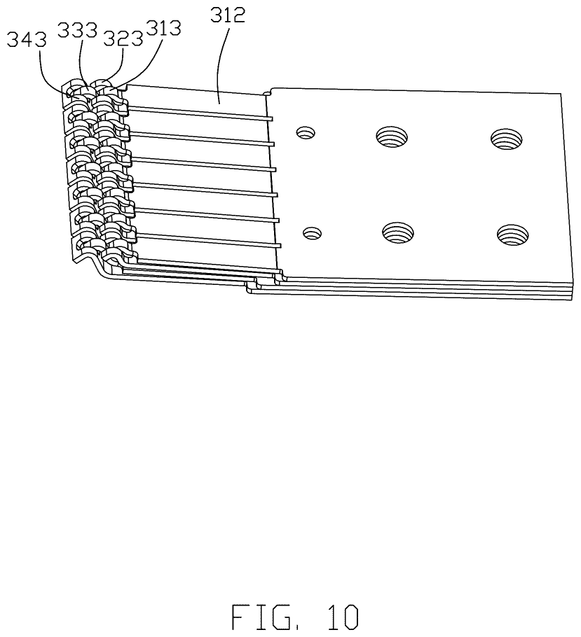

As shown in FIGS. 10-13, the third piece 33 includes a third base portion 331, multiple third elastic arms 332 extending forward from the third base portion 331 in the front-rear direction, and third contact portions 333 arcuately bending from the third elastic arms 332. Each fourth piece 34 includes a fourth base portion 341, multiple fourth elastic arms 342 extending forward from the fourth base portion 341, and fourth contact portions 343 arcuately bending from the fourth elastic arms 342. The third and the fourth piece are sequentially attached to the outer side of the second piece. The fourth contact portions 343 have openings 344, and the third contact portions 333 partially extend into the openings 344 of the fourth contact portions 343. In this embodiment, the openings 324 of the second contact portions penetrate in two directions, forwards in the front-rear direction and in the second direction, the openings 344 of the fourth contact portions are of a closed structure.

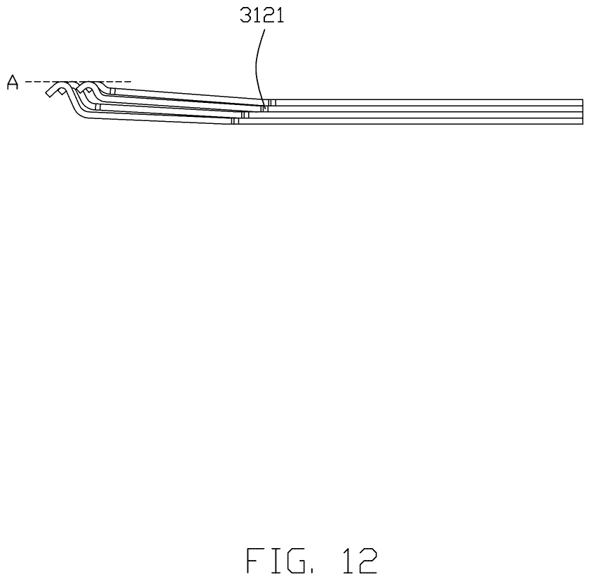

The third contact portions 333 of the third piece are arranged in a single row, and the fourth contact portions 343 of the fourth piece are also arranged in a single row. The third contact portions 333 are positioned behind the fourth contact portions 343 and in front of the second contact portions 323. The first and the third contact portions are aligned one-to-one, and the second and the fourth contact portions are also aligned one-to-one. The width of the second contact portions 323 is the same as the width of the second elastic arms 322, and the width of the fourth contact portions 343 is the same as the width of the fourth elastic arms 342 in the first direction. The widths of the first, the second, the third, and the fourth elastic arms are identical and are aligned one-to-one in the first direction. The first to the fourth elastic arms bend with a small angle from corresponding base portions, sequentially increasing in height, and are spaced apart from one another without being attached in the second direction. Therefore, the first to fourth contact portions are ensured to be positioned on the same virtual insertion plane, as indicated by the dashed line A in FIG. 12. The adjacent elastic arms are spaced from each other and shift outwards in the second direction when the plug portion 11 is inserted to push the elastic arm shift, thereby preventing interference and additional resistance. As shown in FIG. 12, root portions 3121 of the elastic arms connecting to corresponding base portions are arranged in a stepped configuration in the front-rear direction, thereby ensuring that the overall lengths of the first to the fourth elastic arms in the front-rear direction are approximately the same, even if with any differences being limited within 15%.

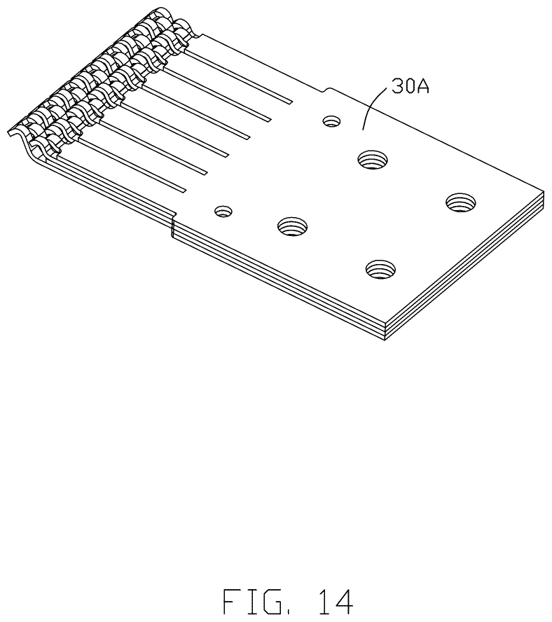

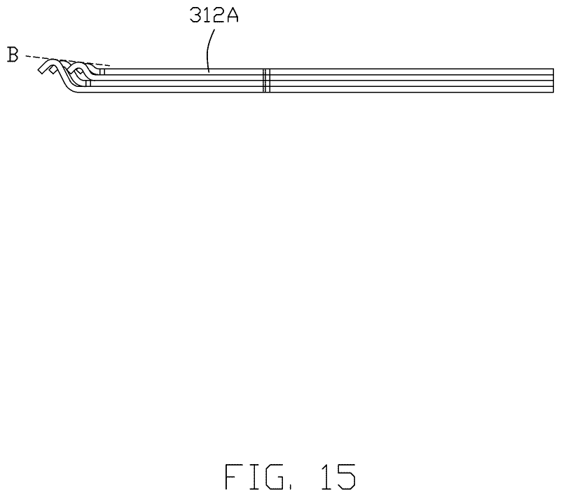

Referring to FIGS. 14-15, a modified structure of the elastic arms of the power terminal 30A is illustrated. The first elastic arm 312A to the fourth elastic arm 342 are attached to one another, with their root portions positioned at the same location in the front-rear direction. The first to the fourth contact portion sequentially increase in height in the second direction, forming a virtual insertion plane (as indicated by the dashed line B in FIG. 15) that is angled relative to the mating slot 401. After the plug portion is inserted, the first to the fourth elastic arms separate from one another to avoid interference. In this embodiment, each of the power terminals has four rows of contact points, thereby significantly reducing contact resistance and improving current-carrying capacity. Additionally, the fourth and the third contact points located at the front, can scrape off surface debris, thereby enhancing the contact performance of the second and the first contact points. Therefore, the power terminals achieve the dual benefits of low resistance and high current-carrying capability.

In the second embodiment, the power connector 400 is connected to a cable 41 at a rear end thereof, the power connector 100 of the first embodiment is mounted on a circuit board. The insulative housing 42 of the power connector 400 has a mating portion 421, a flat portion 422, and a mounting portion 423. The mating portion 421 has the mating slot 401, and the mating portion 421is assembled with a grounding member 43. The mounting portion 423 has two receiving cavity 4231, the cables 41 passes through receiving cavity 4231, and are fixedly connected to the power terminals, respectively. In this embodiment, the cable is a type of a bus bar. Alternatively, the cable is a type of wires.

The mounting portion 423 is hollowed out, exposing the wires or the bus bar in the second direction Z-Z, to increase the heat dissipation space and also facilitates the placement of bolts 461 for securing the bus bar. In this embodiment, one of the bolts 461 is equipped with a temperature sensor 45 to detect temperature changes. The temperature sensor 45 is sleeved onto the bolt 461 and secured by a nut 462, eliminating the need for additional fixing components.

A support member 47 is fixed attached to the first base of the first piece 31. The support member 47 has a spring tab 471 extending from the support member. The spring tab 471 snap into the insulative housing 40 after the power terminal is assembled in the insulative housing 40, enhancing the retention force of the power terminals.

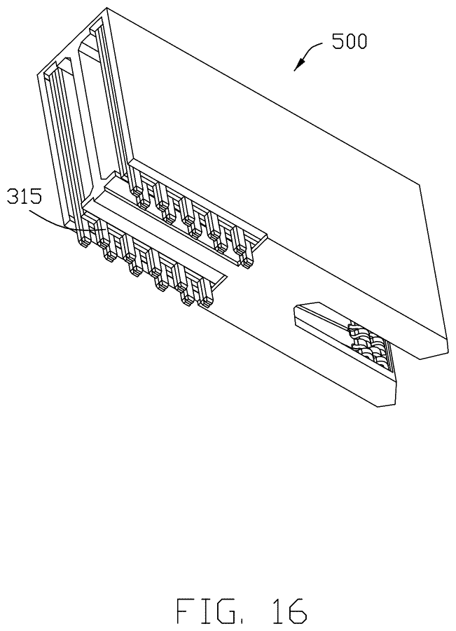

FIG. 16 illustrates a power connector 500 of a third embodiment. Each of the power terminals consists of four terminal pieces. The power connector 500 is mounted on a circuit board. The soldering portions 315 of the first and the second pieces are positioned adjacent to each other, adapted for being inserting into a single soldering hole. The soldering portions 315 of the third and the fourth pieces are positioned adjacent to each other, adapted for being inserting into a single soldering hole. Therefore, the number of soldering holes on the circuit board is reduced to get a compact space.

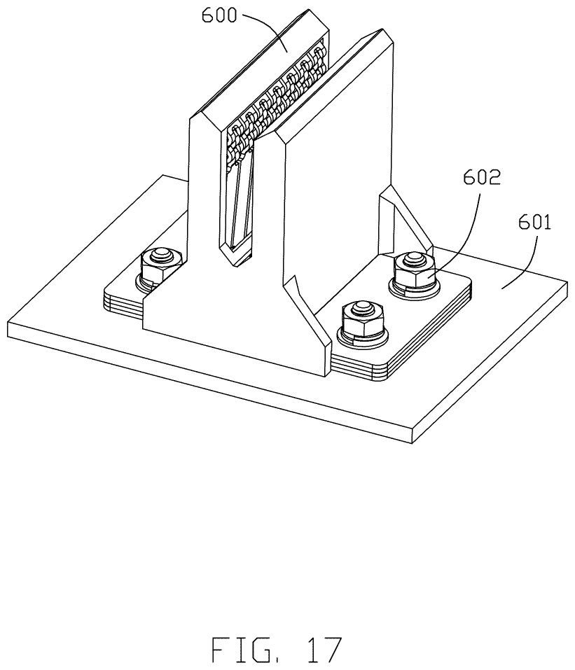

FIG. 17 illustrates a power connector 600 of a fourth embodiment. The power connector 600 is vertically mounted on a copper plate 601. The power terminals are secured to the copper plate through bolts 602.

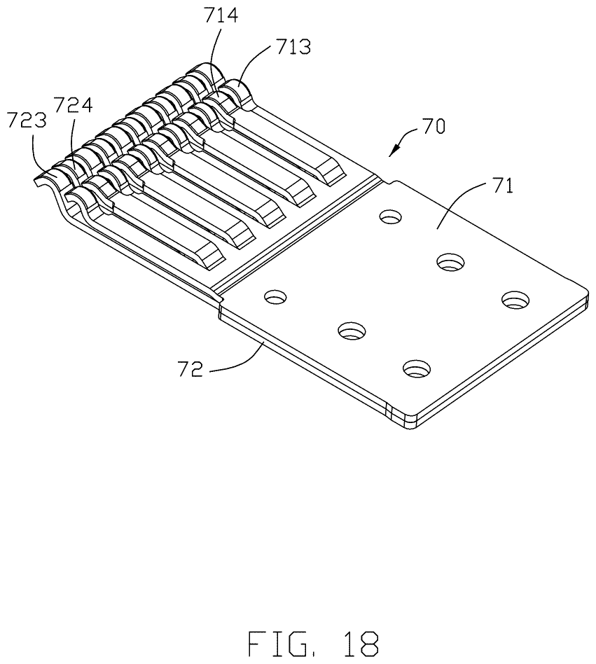

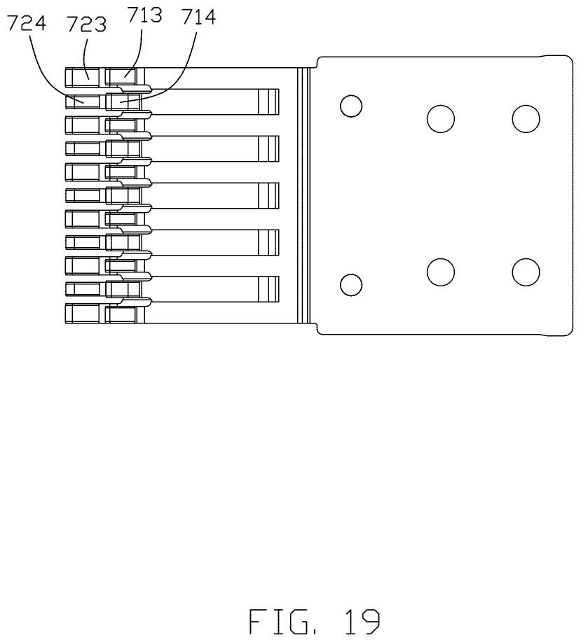

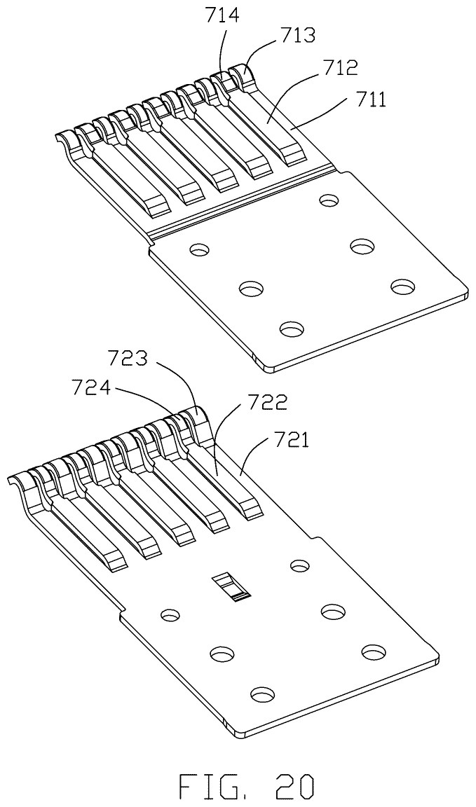

FIGS. 18-20 illustrate a power terminal 70 of the fifth embodiment. The first elastic arms 711 and 712 of the first piece 71 are alternately arranged in the second direction, and the first elastic arms 712 bend inward to avoid interference with adjacent first elastic arms 711. The first contact portions 713 and 714 are located at the front ends of the first elastic arms and are generally arranged in a single row. Likewise, the second elastic arms 721 and 722 of the second piece are alternately arranged, and the second elastic arms 722 bend inward to avoid interference with adjacent second elastic arms 721. The second contact portions 723 and 724 are located at the front ends of the second elastic arms and are also generally arranged in a single row. As shown in FIG. 19, the widths of the first contact portions vary in the first/lateral direction, and the widths of the second contact portions vary in the first/lateral direction.

However, the disclosure is illustrative only, changes may be made in detail, especially in matter of shape, size, and arrangement of parts within the principles of the invention.

1. A power connector comprising:
an insulative housing having a mating slot penetrating forward in a front-rear direction and extending in a first direction perpendicular to the front-rear direction; and
two power terminals located at opposite sides of the mating slot in a second direction perpendicular to the first direction, each of the power terminals comprising a first piece and a second piece stacked at an outer side of the first piece in the second direction;
the first piece comprising a first base portion, plural first elastic arms extending forward from the first base portion, and plural first contact portions bending from the first elastic arms respectively;
the second piece comprising a second base portion, plural second elastic arms extending forward from the second base portion, and plural second contact portions bending from the second elastic arms respectively;
wherein each of the second contact portions has an opening, and the first contact portion partially extends in corresponding opening of the second contact portion.

2. The power connector as claimed in claim 1, wherein the opening penetrates the second contact portion in the second direction, and the opening is a closed hole or a forward-penetrating opening hole.

3. The power connector as claimed in claim 2, wherein the first contact portions of the first piece are arranged in a single row, the second contact portions of the second piece are arranged in a single row, and the first contact portions are positioned behind the second contact portions in the front-rear direction.

4. The power connector as claimed in claim 1, wherein the second elastic arms are located at an outer side of the first elastic arms and are aligned with each other in the second direction.

5. The power connector as claimed in claim 4, wherein a width of the second contact portion is the same as a width of the second elastic arm, and a width of the first contact portion is smaller than a width of the first elastic arm.

6. The power connector as claimed in claim 1, wherein:
each power terminal further comprises a third piece and a fourth piece;
the third piece comprises a third base portion, plural third elastic arms extending from the third base portion, and third contact portions bending from the third elastic arms respectively;
the fourth piece comprises a fourth base portion, plural fourth elastic arms extending forward from the fourth base portion, and plural fourth contact portions bending from the fourth elastic arms; and
the third piece and the fourth piece are sequentially attached to an outer side of the second piece in the second direction.

7. The power connector as claimed in claim 6, wherein each of the fourth contact portions has an opening, and the third contact portion partially extend into corresponding opening of the fourth contact portion.

8. The power connector as claimed in claim 7, wherein the third contact portions are positioned in a single row behind a row of the fourth contact portions and in front of the second contact portions in the front-rear direction.

9. The power connector as claimed in claim 8, wherein the second contact portion and the second elastic arm are of a same width, and the fourth contact portion and the fourth elastic arm are of a same width in the first direction.

10. A power connector comprising:
an insulative housing having a mating slot extending in a front-rear direction and a first direction perpendicular to the front-rear direction; and
two power terminals located at opposite sides of the mating slot in a second direction perpendicular to the front-rear direction and the first direction, each of the two power terminals comprising a first piece, a second piece, a third piece, and a fourth piece arranged from an inner side near the mating slot to an outer side in the second direction;
wherein each piece comprises a base portion, plural elastic arms extending from the base portion, plural contact portions bending from the elastic arms, the contact portions of the first piece and the third piece are aligned with each other in the front-rear direction, and the contact portions of the second piece and the fourth piece are aligned with each other in the front-rear direction.

11. The power connector as claimed in claim 10, wherein from the first piece to the fourth piece, the elastic arms abut against each other and the corresponding contact portions increase in height one-by-one in the second direction.

12. The power connector as claimed in claim 10, wherein from the first piece to the fourth piece, the elastic arms are spaced apart from each other and the corresponding contact portions are at a same height in the second direction.

13. The power connector as claimed in claim 10, wherein each of the second contact portions has an opening, corresponding first contact portion partially extends into the opening of the second contact portion, each of the fourth contact portions has an opening, and corresponding third contact portion partially extends into the opening of the fourth contact portion.

14. A power connector comprising:
an insulative housing having a mating slot penetrating forward in a front-rear direction and a first direction perpendicular to the front-rear direction; and
two power terminals being located at opposite sides of the mating slot, each of the two power terminals comprising a first piece proximately to the mating slot and a second piece stacked with the first piece in a second direction perpendicular to the front-rear direction and the first direction;
the first piece comprising a first base portion, plural first elastic arms extending forward from the first base portion, and plural first contact portions arcuating from corresponding first elastic arms;
the second piece comprising a second base portion, plural second elastic arms extending forward from the second base portion, and second contact portions arcuating from corresponding second elastic arms;
wherein the first base portion is fitly attached to the second base portion, and the end of the first contact portion penetrates over the second contact portion.

15. The power connector as claimed in claim 14, wherein each piece has a rear plate portion extending from corresponding base portion and plural soldering portions extending from corresponding rear plate portion, and the soldering portions of the first piece and the second piece are positioned adjacent to each other.

16. The power connector as claimed in claim 14, wherein the first elastic arms and the second elastic arms are attached to each other one-to-one and the first contact portion is higher than the second contact portion in the second direction.

17. The power connector as claimed in claim 14, wherein from the first piece to the second piece, the elastic arms are spaced apart from each other and the corresponding contact portions are at a same height in the second direction.

18. The power connector as claimed in claim 14, wherein the power terminal includes a third piece attached to the outer side of the second piece, the third piece comprising a third base portion, multiple third elastic arms extending forward from the third base portion, and third contact portions bending from the ends of the third elastic arms respectively, and the end of the second contact portion is penetrated forward to receive the third contact portion.

19. The power connector as claimed in claim 18, wherein the third base portion is attached to the second base portion.
